(19) United States
(12) Patent Application Publication
(10) Pub. No.: US 2025/0004941 A1
(43) Pub. Date: Jan. 2, 2025

(54) SYSTEMS AND METHODS FOR MEMORY MANAGEMENT

(71) Applicant: Xilinx, Inc., Santa Jose, CA (US)

(72) Inventors: Duncan Andrew Cockburn, Edinburgh (GB); David James Fraser, Edinburgh (GB); Inaki Ormaetxea, Edinburgh (GB); Gareth David Edwards, Edinburgh (GB); Dmitri Kitariev, Irvine, CA (US); David Riddoch, Cambridge (GB); Victor Wu, San Jose, CA (US)

(73) Assignee: Xilinx, Inc., Santa Jose, CA (US)

(21) Appl. No.: 18/346,017

(22) Filed: Jun. 30, 2023

(51) Int. Cl. G06F 12/02

(52) U.S. Cl. CPC G06F 12/0292; G06F 2212/174

(57) ABSTRACT

A computer-implemented method for memory management can include identifying a set of one or more memory blocks of virtual memory to be allocated for storage of a content into a plurality of memory banks that subdivide physical memory. The method can include storing the content in the set of one or more memory blocks of virtual memory. The method can include assigning an identifier to the set of one or more memory blocks of virtual memory that store the content. The method can include outputting the identifier for the set of one or more memory blocks of virtual memory. Various other methods, systems, and computer-readable media are also disclosed.

### BACKGROUND

Large-scale communication between or within integrated circuits can occur over congested channels in which the communications can collide. Some communications also rely on the propagation of associated communications, so a delay or collision of one communication can cause a cascading effect of delays. Meanwhile, tracking and monitoring the communications one by one is resource intensive and thus inefficient. Some existing techniques can even drop communications because of the delays and/or collisions.

### BRIEF DESCRIPTION OF THE DRAWINGS

The accompanying drawings illustrate several example implementations and are a part of the specification. Together with the following description, these drawings demonstrate and explain various principles of the present disclosure.

FIG. 1 is a block diagram of an example system for memory management.

FIG. 2 is a block diagram of an additional example system for memory management.

FIG. 3 is a block diagram of an additional example system for memory management.

FIG. 4 is a block diagram of an additional example system for memory management.

FIG. 5 is a flow diagram of an example method for memory management.

FIG. 6 is a flow diagram of an example method for memory management.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the forms disclosed. Rather, the present disclosure covers all modifications, equivalents, and alternatives falling within the scope of the appended claims.

### DETAILED DESCRIPTION

The present disclosure describes examples of systems and methods for memory management. Included are examples of techniques for managing memory utilization to support higher data transmission rates on communication paths, such as within a processing unit, system on a chip, or other integrated circuit, or in other contexts. In some implementations, memory can be efficiently allocated for storing arriving content and then efficiently handle simultaneous requests for access to the content in the memory. Such content can be messages in some cases, such as messages to be exchanged between entities. Such entities can be devices on a network, components of a device, or other entities. Such messages can be packets, in some cases in which the messages are exchanged over a network. Arriving content can, in some implementations, be stored in virtual buffers that can be maintained as memory blocks. The content can be received from or sent to a data channel (e.g., from a network on chip) and/or via data pathways (e.g., via engine paths within a chip for performing operations), and can be stored in such memory blocks. Sets of memory blocks that hold the content can be assigned unique identifiers, which can be used by the memory to fulfill requests to transmit or delete specific content.

In a buffer system through which data traverses, memory access can become a bottleneck and memory collisions can slow down the buffering. For example, memory collisions can occur when multiple write or read operations attempt to use the same portion of memory at the same time. Some implementations described herein include techniques to virtualize memory to reduce chances of collision and/or increase bandwidth and speed of memory operations.

To store content more efficiently in the memory, some implementations described herein can store the content in a linked list of memory blocks. Large content can be assigned multiple blocks while small content (e.g., less than 256 bytes) can be assigned one memory block. Sets of memory blocks can be assigned identifiers to retrieve the sets of the blocks. To handle multiple requests in parallel, the identifiers of the sets of blocks can be stored in an array that is grouped based on how many identifiers can be read at a time, and operations can be applied to the array to quickly extract relevant identifiers and the associated blocks. The blocks themselves can be distributed across the physical memory based on memory utilization levels to reduce the probability of access collisions (e.g., multiple requests to the same memory banks) when those blocks are later accessed to retrieve the content. The memory utilization levels can be identified based on the logical partitions that can be reserved and shared for storage of the blocks.

When the blocks are accessed, the blocks that are being accessed can be monitored to avoid collisions between multiple reads and writes. For example, the blocks and the memory banks in which they are stored can be monitored for access. By monitoring access to the memory banks, the blocks can be erased when their memory banks are not in use to avoid colliding with other access requests to those blocks. A multichannel adapter can further distribute multiple requests across multiple channels so that collisions between multiple requests can be avoided, which can aid in reducing chances of requests being delayed and/or dropped. By virtualizing content across blocks and then controlling how and where those blocks are stored and accessed, some implementations described herein can handle multiple simultaneous write or read operations to memory while reducing chances of bottlenecks and collisions.

As will be described in greater detail below, the present disclosure describes various systems and methods for memory management.

In some implementations, the techniques described herein relate to a computer-implemented method for memory management, the computer-implemented method being performed by a computing device including at least one circuit, the computer-implemented method including: identifying a set of one or more memory blocks of virtual memory to be allocated for storage of a content into a plurality of memory banks that subdivide physical memory; storing the content in the set of one or more memory blocks of the virtual memory; assigning an identifier to the set of one or more memory blocks of the virtual memory that store the content; and outputting the identifier for the set of one or more memory blocks of the virtual memory.

In some implementations, the techniques described herein relate to a computer-implemented method, further including: identifying a second set of one or more memory blocks of the virtual memory that are not associated with the identifier; identifying a subset of the plurality of memory banks that store the second set of one or more memory blocks of the virtual memory; and applying, via each memory bank of the subset of the plurality of memory banks, a reset signal to each block of the second set of one or more memory blocks of the virtual memory.

In some implementations, the techniques described herein relate to a computer-implemented method, wherein identifying the subset of the plurality of memory banks includes: identifying that the subset of the plurality of memory banks that store the second set of one or more memory blocks of the virtual memory are not in use.

In some implementations, the techniques described herein relate to a computer-implemented method, wherein assigning the identifier includes: storing the identifier in an array including one or more identifiers for one or more sets of one or more memory blocks of the virtual memory; applying, responsive to receiving one or more requests for the one or more identifiers, a bitmask to the array based on one or more communication channels associated with the plurality of memory banks; and outputting a subset of the one or more identifiers based on the array after application of the bitmask.

In some implementations, the techniques described herein relate to a computer-implemented method, further including: assigning a respective identifier to each of one or more sets of one or more memory blocks of the virtual memory that store the content.

In some implementations, the techniques described herein relate to a computer-implemented method, wherein assigning the identifier includes: generating a linked list of the set of one or more memory blocks of the virtual memory that store the content; and assigning the identifier to a first block of the linked list.

In some implementations, the techniques described herein relate to a computer-implemented method, further including: assigning each block of the one or more sets of one or more memory blocks to a respective memory bank of the plurality of memory banks; identifying a number of identifiers associated with each of the plurality of memory banks; receiving one or more requests for one or more identifiers of the one or more sets of one or more memory blocks of the virtual memory; and outputting, responsive receiving the one or more requests, the one or more identifiers in an order based on the number of identifiers.

In some implementations, the techniques described herein relate to a computer-implemented method, further including: assigning, based on a size of each memory bank of the plurality of memory banks, the respective identifier to each block of the set of one or more memory blocks of the virtual memory; and assigning, based the respective identifier, each of the set of one or more memory blocks of the virtual memory to a respective memory bank of the plurality of memory banks.

In some implementations, the techniques described herein relate to a computer-implemented method, further including: assigning one or more tags to each of one or more requests for one or more identifiers of one or more sets of one or more memory blocks of the virtual memory; storing the one or more tags in a queue; and removing a respective tag of the one or more tags from the queue responsive to outputting a respective identifier of the one or more identifiers associated with the respective tag.

In some implementations, the techniques described herein relate to a computer-implemented method, further including: receiving, via one or more communication channels, one or more requests for one or more identifiers of one or more sets of one or more memory blocks of the virtual memory; storing, for a respective request of the one or more requests, a respective channel identifier of each of the one or more communication channels associated with the respective request; and transmitting the one or more requests via a plurality of second communication channels, wherein a first number of the one or more communication channels is less than a second number of the plurality of second communication channels.

In some implementations, the techniques described herein relate to a computer-implemented method, wherein: the set of one or more memory blocks of the virtual memory, which are subdivided into the plurality of memory banks, are of equal size; and storing the content in the set of one or more memory blocks of the virtual memory includes: identifying, responsive to receiving the content to be stored, a number of the set of one or more memory blocks of the virtual memory to be allocated to store the content; and storing, responsive to identifying that an available number of memory blocks in the physical memory is at least the number of the set of one or more memory blocks of the virtual memory to be allocated to store the content, the content in the set of one or more memory blocks of the virtual memory to be assigned the identifier identifying a storage location for the content.

In some implementations, the techniques described herein relate to a computer-implemented method, wherein identifying that the available number of memory blocks in the physical memory is at least the number of the set of one or more memory blocks of the virtual memory to be allocated to store the content includes: identifying that a reserved logical partition of allocated responsive to receiving the content to be stored is less than the number of the set of one or more memory blocks of the virtual memory to be allocated to store the content; identifying that the available number of memory blocks in the physical memory is at least the number of the set of one or more memory blocks of the virtual memory to be allocated to store the content; and selecting at least one of the available number of memory blocks in the physical memory as the storage location for the content.

In some implementations, the techniques described herein relate to a system for memory management, the system including: at least one circuit arranged to perform a method including: identifying a set of one or more memory blocks of virtual memory to be allocated for storage of a content into a plurality of memory banks that subdivide physical memory; storing the content in the set of one or more memory blocks of the virtual memory; assigning an identifier to the set of one or more memory blocks of the virtual memory that store the content; and outputting the identifier for the set of one or more memory blocks of the virtual memory.

In some implementations, the techniques described herein relate to a system, wherein the method further includes: identify a second set of one or more memory blocks of the virtual memory that are not associated with the identifier; identify a subset of the plurality of memory banks that store the second set of one or more memory blocks of the virtual memory; and apply, via each memory bank of the subset of the plurality of memory banks, a reset signal to each block of the second set of one or more memory blocks of the virtual memory.

In some implementations, the techniques described herein relate to a system, wherein assigning the identifier includes: store the identifier in an array including one or more identifiers for one or more sets of one or more memory blocks of the virtual memory; apply, responsive to receiving one or more requests for the one or more identifiers, a bitmask to the array based on one or more communication channels associated with the plurality of memory banks; and output a subset of the one or more identifiers based on the array after application of the bitmask.

In some implementations, the techniques described herein relate to a system, wherein the method further includes: assign a respective identifier to each of the set of one or more memory blocks of the virtual memory that store the content.

In some implementations, the techniques described herein relate to a system, wherein the method further includes: assign one or more tags to each of one or more requests for one or more identifiers of one or more sets of one or more memory blocks of the virtual memory; store the one or more tags in a queue; and remove a respective tag of the one or more tags from the queue responsive to outputting a respective identifier of the one or more identifiers associated with the respective tag.

In some implementations, the techniques described herein relate to a system, wherein the method further includes: receive, via one or more communication channels, one or more requests for one or more identifiers of one or more sets of one or more memory blocks of the virtual memory; store, for a respective request of the one or more requests, a respective channel identifier of each of the one or more communication channels associated with the respective request; and transmit the one or more requests via a plurality of second communication channels, wherein a first number of the one or more communication channels is less than a second number of the plurality of second communication channels.

In some implementations, the techniques described herein relate to a system, wherein: the set of one or more memory blocks of the virtual memory, which are subdivided into the plurality of memory banks, are of equal size; and storing the content in the set of one or more memory blocks of the virtual memory includes: identifying, responsive to receiving the content to be stored, a number of the set of one or more memory blocks of the virtual memory to be allocated to store the content; and storing, responsive to identifying that an available number of memory blocks in the physical memory is at least the number of the set of one or more memory blocks of the virtual memory to be allocated to store the content, the content in the set of one or more memory blocks in the virtual memory to be assigned the identifier identifying a storage location for the content.

In some implementations, the techniques described herein relate to a non-transitory computer-readable medium including one or more computer-readable instructions that, when executed by at least one circuit, cause the at least one circuit to perform a method including: identifying a set of one or more memory blocks of virtual memory to be allocated for storage of a content into a plurality of memory banks that subdivide physical memory; storing the content in the set of one or more memory blocks of the virtual memory; assigning an identifier to the set of one or more memory blocks of the virtual memory that store the content; and outputting the identifier for the set of one or more memory blocks of the virtual memory.

Features from any of the implementations described herein can be used in combination with one another in accordance with the general principles described herein. These and other implementations, features, and advantages will be more fully understood upon reading the following detailed description in conjunction with the accompanying drawings and claims.

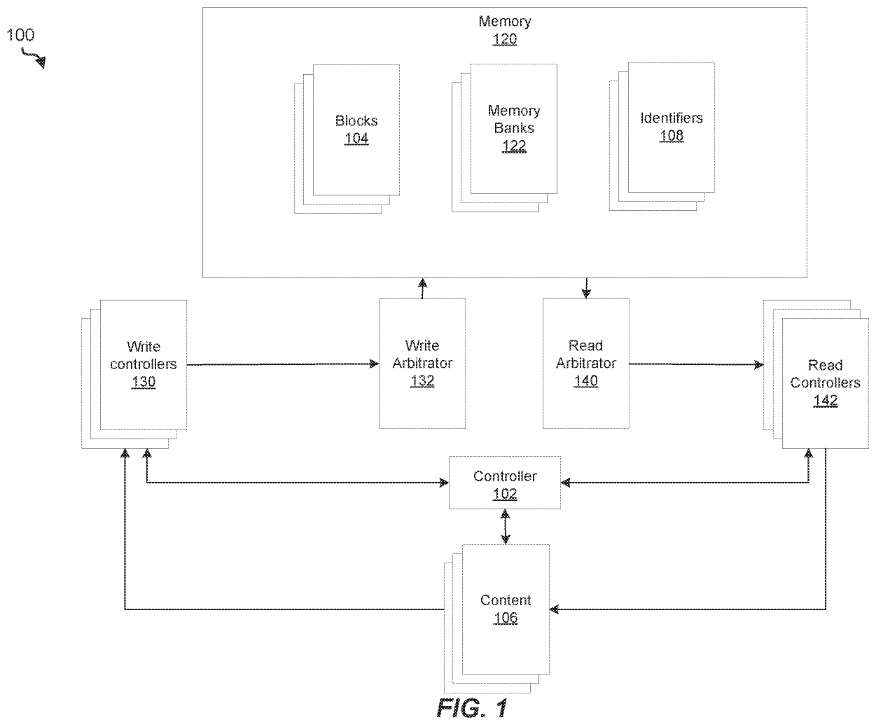

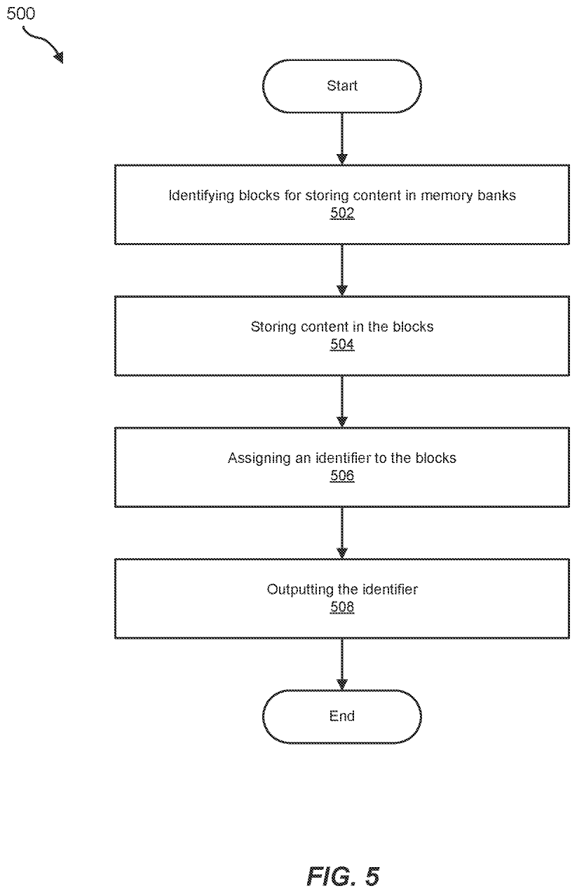

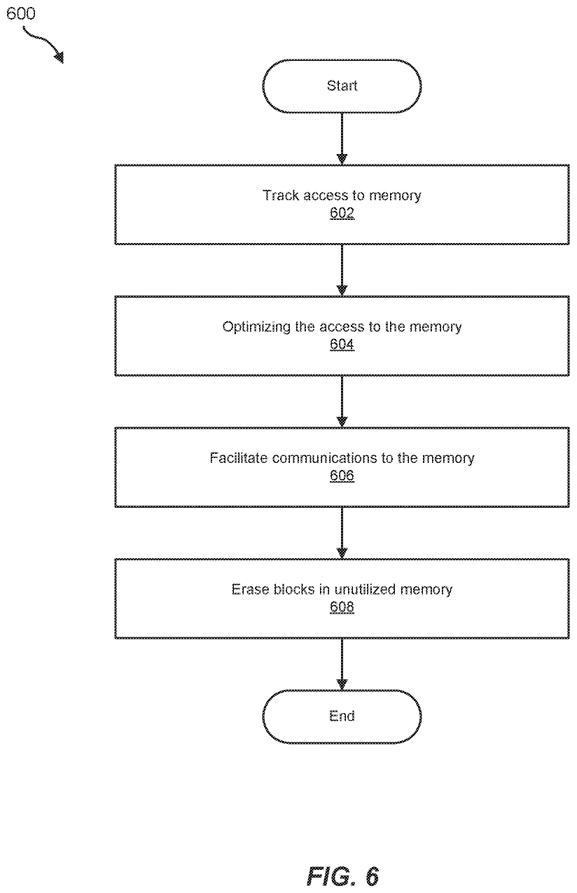

Below are provided, with reference to FIGS. 1-4, detailed descriptions of example systems for memory management. Detailed descriptions of examples of computer-implemented methods are also provided in connection with FIGS. 5 and 6. It should be appreciated that implementations are not limited to operating in accordance with any of the specific examples below, as other variations are possible.

FIG. 1 is a block diagram of an example system 100 for memory management. In some implementations, the system 100 of FIG. 1 can be included within a chip, such as an integrated circuit, system on a chip (SoC), or other chip. In some cases, the chip can be a processing unit, such as a data processing unit (DPU), central processing unit (CPU), or graphics processing unit (GPU). Example system 100 can include a controller 102 for performing one or more tasks, such as in response to computer-readable instructions to be executed by at least one circuit.

The system 100 can be configured to store content 106. Content 106 can be any suitable data from any suitable source, as implementations are not limited in this respect. In some examples, content 106 can be one or more messages being communicated between entities. In cases that the content 106 is one or more messages, the messages can be communicated via any suitable communication medium, as implementations are not limited in this respect. In some cases, the messages can be communicated via a network. In some cases, such a network can be a network interface controller (NIC), network on a chip (NoC) interconnecting components within a chip, such as within a system on a chip (SoC). In other cases, the messages can be communicated via a network between devices, such as a local- and/or wide-area, wired and/or wireless network, including an enterprise network or the Internet. In some scenarios, such as some of those in which content 106 is communicated via a network, a message can be arranged as one or more packets. Accordingly, in some cases, receiving, storing, and outputting the content 106 can include receiving, storing, and outputting one or more packets.

In some implementations, the content 106 can arrive at the depicted components of system 100 via one or more data-in channels. As should be appreciated from the foregoing, the data-in channels can in some cases be receiving data from an interconnect fabric of an integrated circuit, such as a network on a chip (NoC), network interface controller (NIC), or other interconnect. In other cases, the data-in channels can receive the content 106 from a different communication medium or mechanism. In some implementations, rather than a data-in channel, content 106 can be received via a different interface or input mechanism.

In some cases, content 106 can additionally or alternatively arrive at the depicted components of system 100 via one or more data paths of the system 100. The data paths of the system 100 can include one or more components to perform one or more operations on content 106, such as operations defined by one or more computer-readable instructions to be executed by the component(s) of the data path. In some cases, different data paths can include different components and/or be configured to perform different functions in response to computer-readable instructions or be able to execute different computer-readable instructions. It should be appreciated, however, that variations are not limited to implementing data paths in any particular manner. In some implementations that include such data paths, there can be multiple data paths, such as four data paths.

The memory 120 (e.g., RAM) of system 100 can include memory banks 122 (e.g., RAM cells) that subdivide the memory 120 for efficiently distributing the memory blocks 104 for storage. For example, memory 120 can be physical memory, and the physical memory can be subdivided into different regions for access (e.g., read/write) and management. The subdivisions of the memory 120 can virtualize the memory for management. In some cases, subdividing the memory can enable increased efficiency in use of the memory, such as by enabling a reduction in memory collisions. Such memory collisions can include when a write operation is looking to use a same or similar part of memory as a read operation, when the read and write operations are being performed in parallel.

The memory banks 122 can be arranged in a variety of ways. In some implementations, the memory banks 122 are of equal size and subdivide the memory 120. For example, the memory banks 122 can be equal by being 16 bytes each. In another example, the memory 120 can include 128 of the memory banks 122 that are each 16 bytes. In some cases, the memory banks 122 can be further subdivided into memory blocks 104. In some such cases, the memory blocks 104 are of equal size. For example, the memory blocks 104 can be equal size of 16 bytes. In another example, the memory blocks 104 can be equal size of 128 bits. The memory blocks 104 can in some such implementations be a minimum unit of memory to be allocated, and when content 106 is to be stored, a number of the memory blocks 104 (e.g., one or more of the memory blocks 104) can be allocated that provide an amount of storage in memory 120 that is equal to or greater than the amount of data to be stored for the content 106. Accordingly, in some implementations, when content 106 is to be stored, a set of one or more of the memory blocks 104 can be allocated to the storage of the content 106.

Such a set of the memory blocks 104 can in some implementations be identified by identifiers 108. The identifiers 108 can be buffer identifiers for a buffer that is formed of the memory block(s) of a set of the memory blocks 104. Because the identifiers 108 are specific to the buffer formed for storage of the content 106, the identifiers 108 can be limited-use identifiers that is usable while the content 106 is stored in the set of the memory blocks 104, and when the content 106 is removed from memory 120 (for any suitable purpose, including that the content 106 has been read back out of the memory blocks 104 or is no longer needed to be stored) the identifiers 108 can no longer be usable to access the content 106. In some implementations in which the identifiers 108 are assigned to a set of the memory blocks 104, the identifiers 108 can be stored in the memory 120 and can be subsequently used to access the buffer and/or set of blocks. For example, the identifiers 108 can be provided in a read instruction to request that the content 106 stored in the set of the memory blocks 104 associated with the identifiers 108.

In some implementations that include data paths within the system 100, such as that send data to or receive data from the components depicted in FIG. 1, content 106 that is stored in a set of the memory blocks 104 as a buffer can be content 106 received from one or more of the data paths of the system 100. For example, content 106 that is to be processed per a function to be executed on a data path, or that results from performance of a function on a data path, can be stored in a set of the memory blocks 104 as a buffer.

As another example of usage of memory 120, in some implementations, a set of one or more of the memory blocks 104 can be arranged as a first-in, first-out (FIFO) queue. In such a queue, content 106 that is added to the queue in an order can be retrieved from the queue in the same order. In some implementations that include data-in channels, a FIFO queue can be maintained for each of the channels. When content 106 is received via a channel, the content 106 can be stored in one or more of the memory blocks 104 of the FIFO corresponding to an amount of data for the content 106. In some such implementations, each such FIFO queue can be assigned an identifier that can be used to write content 106 to and read content 106 from the FIFO queue.

Example system 100 can include write controllers 130 (e.g., 1-10 controllers) configured to identify memory blocks 104 that are available for storing content 106 and for requesting that content 106 be stored in available memory blocks of the memory blocks 104. The write controllers 130 can be one or more integrated circuits, software applications, firmware, or programs that, when executed by a computing device, CPU, GPU, or DPU, can perform one or more tasks. The system 100 can include a write arbitrator 132 configured to receive an identification of the memory blocks 104 from the write controllers 130 and write content 106 into those memory blocks 104. The write arbitrator 132 can be configured to store the content 106 in the memory blocks 104 in the memory 120. The write arbitrator 132 can output the identifiers 108 to identify the memory blocks 104 that were used to store content 106. When write arbitrator 132 writes the memory blocks 104 to the memory 120, the identifiers 108 (e.g., Buffer ID) can be returned to an origin of the content 106 (e.g., an entity that requested the content 106 be written to memory) to allow subsequent random access to that buffer in the future by that entity or by another entity that receives the identifier indicating where the content 106 is stored.

The system 100 can include a read arbitrator 140 configured to receive the identifiers 108 from the read controllers 142 (e.g., 1-10 controllers) to read the memory blocks 104 from the memory 120. The read controllers 142 can be one or more integrated circuits, software applications, firmware, or programs that, when executed by a computing device, CPU, GPU, or DPU, can perform one or more tasks. The read arbitrator 140 can be configured to read the memory blocks 104 from the memory banks 122 and provide the memory blocks 104 based on the identifiers 108 for transmittal to the read controllers 142 to output the content 106. For example, in response to a read command, the read arbitrator 140 can transmit the memory blocks 104 via the engine paths to the read controllers 142 for being returned to the user logic or network on chip through the data out channel hub, or simply dropped or removed from the memory 120 entirely.

Although illustrated as separate elements, the system 100 in FIG. 1 can represent portions of a single module or application.

As discussed above, in certain implementations, the system 100 in FIG. 1 can represent one or more software applications or programs that, when executed by a computing device, can cause the computing device to perform one or more tasks. For example, and as will be described in greater detail below, the system 100 can include modules stored and configured to run on one or more computing devices. The system 100 in FIG. 1 can also represent all or portions of one or more special-purpose computers configured to perform one or more tasks.

As illustrated in FIG. 1, example system 100 can also include one or more memory devices, such as memory 120. Memory 120 generally represents any type or form of volatile or non-volatile storage device or medium capable of storing data and/or computer-readable instructions. In one example, memory 120 can store, load, and/or maintain one or more of the memory blocks 104, the content 106, and the identifiers 108 in memory banks 122. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include the controller 102. The controller 102 can generally represents any type or form of hardware-implemented and/or computer-implemented processing unit capable of interpreting and/or executing computer-readable instructions. In one example, the controller 102 can access, control, and/or modify one or more of the memory blocks 104, the content 106, the identifiers 108, the memory 120, the write controllers 130, the write arbitrator 132, the read arbitrator 140, and/or the read controllers 142. Examples of the controller 102 includes, without limitation, microprocessors, microcontrollers, data processing unit (DPUs), Graphics Processing Units (GPUs), Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

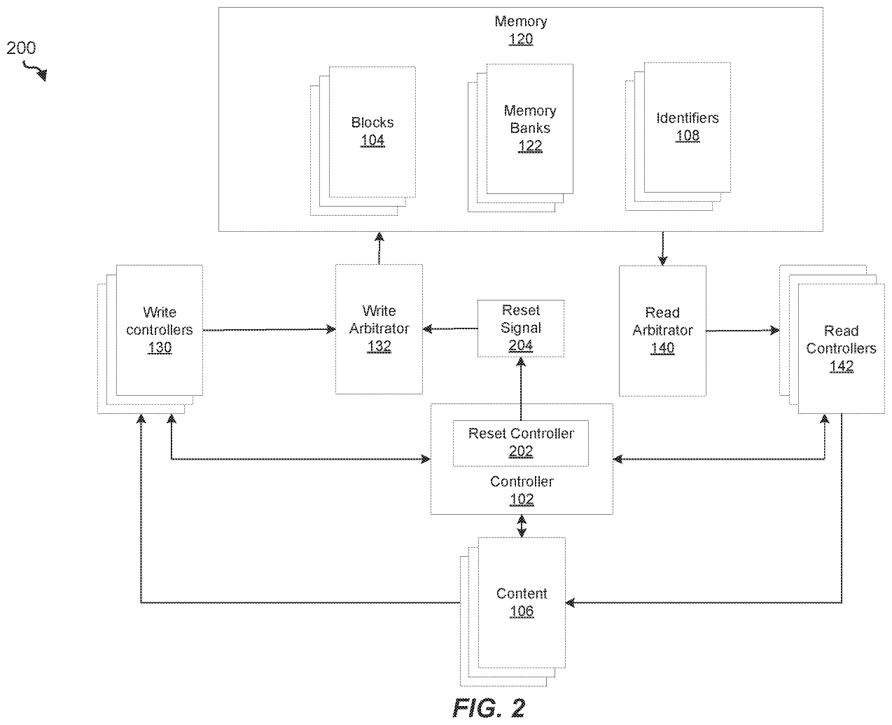

As illustrated in FIG. 2, example system 200 can include a reset controller 202 configured to erase memory banks 122 that hold memory blocks 104 that are not in use (e.g., not associated with identifiers 108). For example, the reset controller 202 can free the memory banks 122 and/or memory blocks 104 of the memory banks 122, to enable the memory banks 122 and/or memory blocks 104 to store the content 106. Erasing/freeing the one or more of the memory blocks 104 can include storing an initialization data in the memory blocks 104 (e.g., all 1s, all 0s, or another pattern) to reduce a risk of inadvertent data misuse or mis-accessing if prior data remained in the one or more of the memory blocks 104 that were re-allocated to another entity. The reset controller 202 can identify the memory blocks 104 to be reset. The reset controller 202 can issue a reset signal 204 to the write arbitrators 132 to cause the memory banks 122 to be erased. In one example, the controller 102 can access, control, and/or modify the reset controller 202.

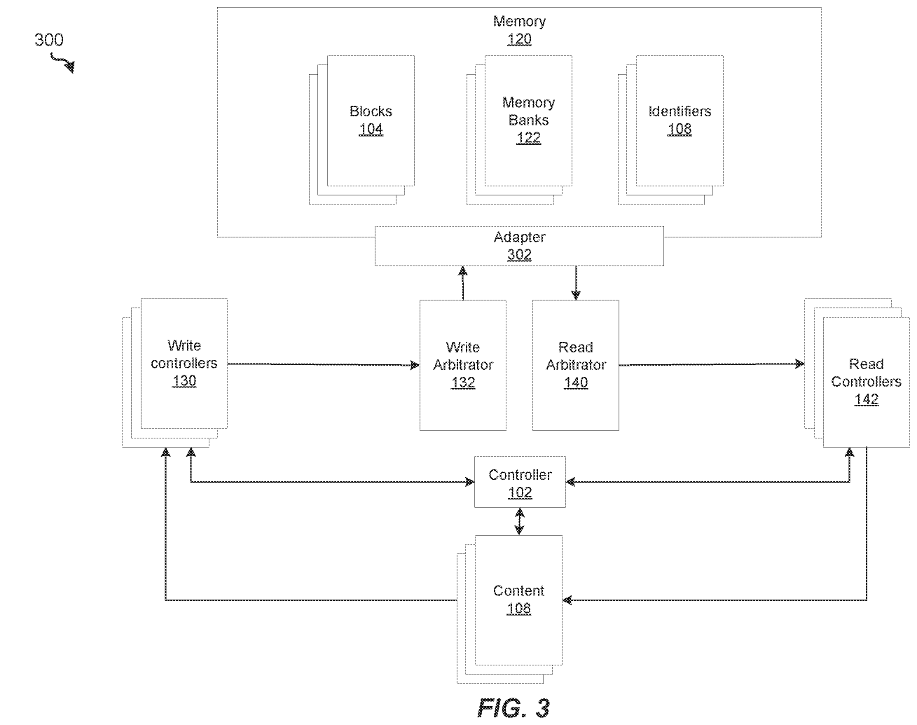

As illustrated in FIG. 3, example system 300 can include an adapter 302 that can distribute the requests across multiple channels. The adapter 302 can increase bandwidth between the write controllers 130 and the read controllers 142 and the memory 120 by distributing the communications between the write controllers 130 and the read controllers 142 across additional communication channels within the adapter 302. For example, since the memory 120, the write controllers 130, and the read controllers 142 can have 4 channels in which requests can collide, the adapter 302 can have 5 channels placed between the write controllers 130 and the read controllers 142 and the memory 120 to increase bandwidth.

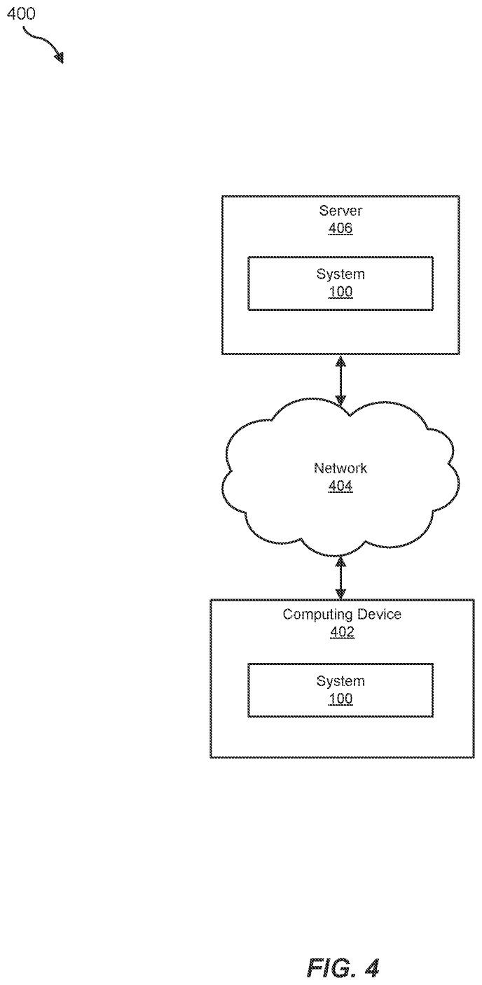

Systems 100-300 can be implemented in a variety of ways. For example, all or a portion of systems 100-300 can represent portions of system 400 in FIG. 4. As shown in FIG. 4, system 400 can include a computing device 402 in communication with a server 406 via a network 404. In one example, all or a portion of the functionality of the systems 100-300 can be performed by computing device 402, server 406, and/or any other suitable computing system. As will be described in greater detail below, the system 400 from FIG. 4 can, when executed by at least one processor and/or circuit of the computing device 402 and/or server 406, enable computing device 402 and/or server 406 to conduct memory management.

Computing device 402 generally represents any type or form of computing device capable of reading computer-readable instructions. For example, the computing device 402 can include a network interface controller (NIC) that includes the system 100. Additional examples of computing device 402 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 406 generally represents any type or form of computing device that is capable of memory management. For example, the server 406 can include a network interface controller (NIC) that includes one or more of the systems 100-300 of FIGS. 1-3. Additional examples of the server 406 include, without limitation, storage servers, database servers, application servers, and/or web servers configured to run certain software applications and/or provide various storage, database, and/or web services. Although illustrated as a single entity in FIG. 4, the server 406 can include and/or represent a plurality of servers that work and/or operate in conjunction with one another.

The network 404 generally represents any medium or architecture capable of facilitating communication or data transfer. In one example, network 404 can facilitate communication between computing device 402 and server 406. In this example, network 404 can facilitate communication or data transfer using wireless and/or wired connections. Examples of network 404 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to one or more of systems 100-400 of FIGS. 1-4. Conversely, all the components and devices illustrated in systems 100-400 need not be present to practice the implementations described and/or illustrated herein. The devices and subsystems referenced above can also be interconnected in different ways from that shown in FIG. 4. Systems 100-400 of FIGS. 1-4 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, non-transitory computer-readable medium, non-transitory computer-readable medium, or medium capable of storing or carrying computer-readable instructions. Examples of computer-readable media or non-transitory computer-readable medium include, without limitation, transmission-type media, such as carrier waves, and non-transitory computer-readable medium type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other non-transitory computer-readable medium or non-transitory computer-readable medium distribution systems.

FIG. 5 is a flow diagram of an example computer-implemented method 500 for memory management. Memory can be efficiently allocated for storing arriving content and then efficiently handle simultaneous requests for access to the memory to stream the content (e.g., packets or messages). The arriving content can be stored in virtual buffers (e.g., memory blocks). The content can be received from a data channel (e.g., from a NoC or NIC) and transmitted via data pathways (e.g., via engine paths) for storage in memory blocks. The steps shown in FIG. 5 can be performed by any suitable computer-readable code and/or circuit arranged to perform the computer-implemented method 500, including system 100 in FIG. 1, system 200 in FIG. 2, system 300 in FIG. 3, system 400 in FIG. 4, and/or variations or combinations of one or more of the same. In one example, each of the steps shown in FIG. 5 can represent an algorithm whose structure includes and/or is represented by multiple sub-steps, examples of which will be provided in greater detail below.

As illustrated in FIG. 5, at step 502, the controller 102 can identify memory blocks 104 for storing content 106 in the memory banks 122. The controller 102 can receive the content 106, which can be segmented input data. The controller 102 can analyze the content 106 and identify the start and end of the content 106. For example, the controller 102 can identify contextual information in the content 106 based on the start of the packets (SOP). In another example, the controller 102 can identify status information based on the end of packet (EOP). While determining whether the content 106 can be stored, the controller 102 can store the content 106 in a buffer while determining where to store the content 106. For example, the content 106 can be stored in a skid buffer for timing purposes.

The controller 102 can manage one or more of the memory blocks 104 of virtual memory to be allocated for storage of the content 106 into the memory banks 122 that subdivide the memory 120. In some implementations, the controller 102 can identify and/or maintain a list of the memory blocks 104 for storage of content 106. For example, the controller 102 can maintain a listing of the memory blocks 104 in which content 106 can be stored. The list of the memory blocks 104 can include an identifier of each memory block of the memory blocks 104.

The controller 102 can generate, for each memory block of the memory blocks 104, an identifier that can represent a starting address location in the memory 120. For example, each starting address location can be 256 bytes in length, and the memory 120 can be RAM that includes 128 memory banks of 128 bits (16 bytes) each. Each memory block of the memory blocks 104 can be maintained in a queue of virtual memory (e.g., 8 FIFOs) for storage in the memory banks 122 (e.g., RAM banks). The memory blocks 104 that are can be identified in virtual memory, such as 8 Dual Port FIFOs. The memory blocks 104 can be initialized with an identifier, such as a counter from 0 to 24575. Each listing of the memory blocks 104 can have an identifier that corresponds to the identifier. For example, each queue of memory blocks 104 can have an identifier that corresponds to 3 bits of the memory block of the memory blocks 104. Based on the 3 bits, each queue of 256-byte blocks can be associated with one of the memory banks 122 of the memory 120 (e.g., 16 RAM cells).

The controller 102 can receive requests to identify memory blocks 104 that are available for storing the content 106. For example, the controller 102 can transmit the content 106 into a request block to request memory blocks 104 for storing the content 106. In some implementations, the controller 102 can receive a plurality of requests to identify a plurality of identifiers of sets of the one or more of the memory blocks 104 of virtual memory. For example, interfaces that store data in virtual buffers or virtual memory can request memory blocks 104 that are available. In another example, the controller 102 can manage buffers to request memory blocks 104. The controller 102 can maintain the requests in a queue of requests and identify each request with an index. The requests can be propagated to the write controllers 130 through request channels or engine paths. For example, the requests can be propagated through a 4 to 1 request multiplexor.

The controller 102 can allocate, during each clock cycle, the memory blocks 104 based on a priority indicated by the index. For example, an index of 0 can indicate the highest priority. If there are multiple requests (e.g., odd number such as 1 or 3) across multiple channels (e.g., 4) in a clock cycle, the controller 102 can select the memory blocks 104 based on the priority in each clock cycle. For example, the write controllers 130 can use the priority index to allocate memory blocks 104 during the next clock cycle among the channels (e.g., allocate to 2 channels during one cycle and 2 channels during the next cycle to allocated evenly across 4 channels).

The controller 102 can store the content 106 in sets of one or more of the memory blocks 104 of virtual memory. In some implementations, the controller 102 can identify, in response to receipt of the content 106 to be stored, a number of the memory blocks 104 of virtual memory needed to store the content 106. Based on start and end of the content 106, the controller 102 can determine how many of the memory blocks 104 are necessary to store the content 106. For example, the controller 102 can identify the SOP of the content 106 and identify the contextual information of the content 106 based on the SOP. Based on the contextual information, the controller 102 can identify the size, offset, and/or logical partition to determine the number of blocks needed to store the content 106. The controller 102 can request the determined number of the memory blocks 104 from memory 120 to store the memory blocks 104.

The controller 102 can compare the number of the memory blocks 104 needed to store the content 106 to the number of the memory blocks 104 that are available in the memory 120. To determine how many of the memory blocks 104 are available, during each clock cycle, the controller 102 can maintain one or more interfaces (e.g., counters) to track how many of the memory blocks 104 are available in memory 120. Based on the comparison, the controller 102 can generate a response message indicating that the content 106 can be stored or that there are not enough of the memory blocks 104 available. The controller 102 can update the interface (e.g., update the counter) after each request to store the memory blocks 104, during each clock cycle, based on whether the request was granted or rejected.

If the memory blocks 104 are available in the memory 120, then the controller 102 can store the content 106 in those memory blocks 104. In some implementations, the controller 102 can store, in response to identifying that an available number of memory blocks in the memory 120 is at least the number of the set of one or more of the memory blocks 104 of virtual memory to be allocated to store the content 106, the content 106 in the one or more of the memory blocks 104 to be assigned the identifier identifying a storage location for the content 106. For example, each of the available number of the memory blocks 104 can store 256 bytes of data. In some implementations, the controller 102 can store large (e.g., more than 256 bytes) content 106 across the memory blocks 104. In some implementations, the controller 102 can store small (e.g., less than 256 bytes) content 106 in one of the one or more of the memory blocks 104.

To handle storage of the content 106 in the memory 120, the controller 102 can apply memory management techniques (e.g., pool management) to reserve and/or allocate logical partitions (e.g., pools) in the memory banks 122 (e.g., atomic units) of the memory 120 (e.g., memory resource) for memory blocks 104 to store the content 106. The controller 102 can initialize, select, or receive (e.g., compile-time parameters) the number of logical partitions, the number of requestors, and the size of the memory 120 that can be utilized. The controller 102 can select, for each partition, a limit for specifying a reservation size that guarantees that reserved partition access to a minimum number of the memory banks 122.

The controller 102 can monitor the utilization of the reserved logical partitions to determine whether the content 106 can be stored and on which partition. During each clock cycle, the controller 102 can identify which logical partitions are reserved (e.g., guaranteed) for the memory blocks 104 to be stored. To track utilization of the reserved logical partition, the controller 102 can maintain a counter indicative of the availability of the reserved logical partition. When the controller 102 receives the requests to store content 106, the controller 102 can use the counter of the reserved logical partition to identify the number of the memory blocks 104 that are available. The controller 102 can compare the number of the memory blocks 104 needed to store the content 106 to the number of the memory blocks 104 that are available in the reserved logical partitions.

Based on the comparison, the controller 102 can allocate and/store the content 106 in memory blocks 104 in the selected reserved logical partitions associated with the memory banks 122. The controller 102 can either respond that the content 106 can be stored in the memory banks 122 or that there are not enough of the memory blocks 104 available. If the memory blocks 104 are available in the memory banks 122, then the controller 102 can store the content 106 in those memory blocks 104. In some implementations, the controller 102 can store the content 106 after identifying that the available number of the memory blocks 104 in the memory banks 122 is at least the number of the set of one or more of the memory blocks 104 of virtual memory to be allocated to store the content 106. The controller 102 can update, during each clock cycle, the counter for the reserved logical partition based on how much memory was utilized (e.g., number of the memory blocks 104 requested or freed) in the reserved logical partition.

In some implementations, in response to receipt of the content 106 to be stored, the controller 102 can identify that the availability in the reserved logical partition is less than the number of the memory blocks 104 of virtual memory needed to store the content 106. For example, the controller 102 can use the counter to identify the number of available blocks in the reserved logical partition. If there is an insufficient number of the memory blocks 104 available in the memory banks 122, then the controller 102 can determine whether the content 106 can be stored in memory banks 122 that are shared between requests.

In some implementations, the controller 102 can allocate and/or store the memory blocks 104 in shared logical partitions (e.g., common pool) among memory requests to fill in shortages in the reserved partitions. The controller 102 can initialize, select, or receive (e.g., compile-time parameters) the size of the shared logical partition that can be utilized. The controller 102 can select, for each partition, a limit for specifying a how much memory can be requested from the shared logical partition. To track utilization of the shared logical partition, the controller 102 can maintain a counter indicative of the availability of the shared logical partition.

The controller 102 can conditionally request additional memory blocks of the memory blocks 104 (e.g., beyond the memory in the reserved logical partition) from the shared logical partitions. To determine the availability of the shared logical partition, the controller 102 can use the counter of the reserved logical partition to identify the number of the memory blocks 104 that are available. If the memory blocks 104 are available in the shared logical partitions, then the controller 102 can store the content 106 in those memory blocks 104. The controller 102 can compare the number of the memory blocks 104 needed to store the content 106 to the number of the memory blocks 104 that are available in the shared logical partition.

Based on the comparison, the controller 102 can generate a response message indicating that the content 106 can be stored (e.g., success message) or that there are not enough of the memory blocks 104 available (e.g., failure message). The controller 102 can store the response message a response queue and forward the message to an event processor and/or or the write controllers 130. Based on the response message, the write controllers 130 can store or not store the content 106. In response to the response message indicating that the content 106 can be stored, the write controllers 130 can store the content 106. In response to the response message indicating that the content 106 cannot be stored, the write controllers 130 would decline to store the content 106. For example, the controller 102 can store the content 106 in the shared logical partition if the requested size does not exceed what is available in the shared logical partition. In some implementations, the controller 102 can identify that the available number of the memory blocks 104 in the shared logical partitions is at least the number of the set of one or more of the memory blocks 104 of virtual memory to be allocated to store the content 106. In some implementations, the controller 102 can select the one or more of the memory blocks 104 from the shared logical partition in the memory 120 as the storage location for the content 106. The controller 102 can update, during each clock cycle, the counter for the shared logical partition based on how much memory was utilized (e.g., number of the memory blocks 104 requested or freed) in the shared logical partition.

As illustrated in FIG. 5, at step 504, the controller 102 of the systems described herein can store the content 106 in the memory blocks 104. When the controller 102 identifies the one or more of the memory blocks 104 as available for storing content 106, the controller 102 can select the one or more of the memory blocks 104 from the memory banks 122. For example, up to four of the memory blocks 104 can be issued for storage of content 106 every clock cycle. In some implementations, the controller 102 can output, responsive to receipt of the plurality of requests, the plurality of identifiers of memory blocks 104 in an order based on the number of available memory blocks of the memory blocks 104 in the memory banks 122. For example, the controller 102 can output identifiers of memory blocks 104 in memory banks 122 that have the most available memory blocks of the memory blocks 104.

To distribute the usage of memory blocks 104 among the memory banks 122, the controller 102 can monitor the utilization levels across the memory banks 122. In some implementations, the controller 102 can identify one or more of the memory blocks 104 associated or stored on each of the memory banks 122. For example, one or more of the identifiers 108 can indicate a fill level of memory blocks 104 in the memory banks 122. The controller 102 can maintain a ranked order of the fill level of the memory blocks 104 in each of the memory banks 122. For example, the controller 102 can generate the ranked order by performing a bitonic sort of the memory banks 122 during every clock cycle. In another example, the controller 102 can apply a rotation algorithm to switch the order of the memory banks 122 to prevent any one of the memory banks 122 from being overutilized. In another example, the controller 102 can identify when one or more of the memory banks 122 are empty and/or do not include any memory blocks 104 that are available for storing content 106.

The controller 102 can select the memory blocks 104 in the memory banks 122 based on the ranked order of available blocks in each of the memory banks 122. For example, the controller 102 can select memory blocks 104 from the memory banks 122 that has the greatest number of available memory blocks of the memory blocks 104. The controller 102 can select blocks with identifiers 108 associated with the memory banks 122 that have the greatest number of available memory blocks of the memory blocks 104. By selecting memory blocks 104 from the memory banks 122 that have the greatest number of available memory blocks of the memory blocks 104, the controller 102 can distribute utilization of the memory blocks 104 across the memory banks 122 to improve performance. For example, the distribution of memory blocks 104 from different memory banks can reduce the probability that memory blocks 104 are assigned to a single memory bank that is then used disproportionately. The controller 102 can return the one or more of the memory blocks 104 (e.g., as available blocks) to the memory banks 122 when the one or more of the memory blocks 104 are freed or not used. For example, unused memory blocks of the memory blocks 104 can be returned to the memory banks 122 via return pathways (e.g., a set of 4 Feedback Return FIFOs). The controller 102 can apply a multiplexer between the return queues and the return pathways to reinsert the memory blocks 104 into the memory banks 122 as available blocks.

The controller 102 can distribute the memory blocks 104 across the memory banks 122 of the memory 120 to reduce the probability of collisions (e.g., multiple requests to the same memory bank) for later access of the memory blocks 104 to retrieve the content 106. In some implementations, the controller 102 can assign, based on a size of each memory bank of the memory banks 122, each of the memory banks 122 (e.g., respective memory bank) for each block of the set of one or more of the memory blocks 104 of virtual memory. For example, the controller 102 can assign each block of the set of one or more of the memory blocks 104 to a different memory bank (e.g., different respective memory bank) of the memory banks 122. The controller 102 can assign the one or more of the memory blocks 104 to the memory banks 122 based on the identifiers of the memory blocks 104. For example, the controller 102 can use the identifiers of the memory blocks 104 to randomize (e.g., divide the identifiers by a number) the memory banks 122 to which the memory blocks 104 are assigned. In some implementations, the controller 102 can assign, based on the identifiers 108, each of the set of the one or more of the memory blocks 104 to a respective memory bank of the memory banks 122. For example, the controller 102 can assign some of the memory blocks 104 to different memory banks to distribute the memory blocks 104 across the memory banks 122, which can enable faster access to the memory blocks 104 when compared to storing all the memory blocks 104 in one storage location or memory bank and then retrieving the blocks from that one memory bank.

In some implementations, the controller 102 can generate a linked list of the set of the one or more of the memory blocks 104 of virtual memory to store the content 106. For example, the one or more of the memory blocks 104 can be a FIFO where the content 106 is stored. In some implementations, the controller 102 can assign a respective identifier to each of the set of the one or more of the memory blocks 104 of virtual memory that store the content 106. For example, each of the one or more of the memory blocks 104 can be identified by a respective identifier to link the memory blocks 104 together. In some implementations, the controller 102 can store the content 106 in a linked list of the memory blocks 104. In some implementations, the controller 102 can assign the respective identifier based on respective memory addresses of the memory banks 122 (e.g., RAM cells) of the memory 120 (e.g., RAM). For example, if the identifier matches the memory address, then the controller 102 can use the identifier to access the memory banks 122 to access the memory blocks 104 instead of having to use the identifier to first look up the memory address of the memory banks 122 on which the memory blocks 104 are stored. Such addressing techniques can be useful for high-speed access because any input (e.g., request to look up memory blocks 104 associated with identifiers 108) can be quickly queried against the memory banks 122 (e.g., each respective memory bank) where individual memory blocks of the memory blocks 104 can be stored.

As illustrated in FIG. 5, at step 506 the controller 102 described herein can assign the identifiers 108 to the memory blocks 104. For example, the controller 102 can assign the identifiers 108 to the set of one or more of the memory blocks 104 of virtual memory that store the content 106. The identifiers 108 can then be used to retrieve the memory blocks 104 that store the content 106. For example, the identifiers 108 can be received in a read request of the content 106, and the memory blocks 104 for the content 106 can be retrieved to fulfill the request to transmit or delete the content 106.

In some implementations, the controller 102 can assign the identifiers 108 to generate a linked list of the memory blocks 104 that store the content 106. For example, the controller 102 can assign a unique identifier of the identifiers 108 to each set of the memory blocks 104 that hold the content 106. In some implementations, the controller 102 can assign an identifier of the identifiers 108 to a first block (e.g., head pointer) of the linked list. For example, the controller 102 can assign the identifier to the first block so that the set of the memory blocks 104 can be accessed using the supplied head pointer. Assigning the identifier to the first block of a linked list can allow for more efficient access to the sets of the memory blocks 104. For example, the controller 102 can use the identifier of the first block to access the linked list of all the memory blocks 104. For content 106 stored in one memory block (e.g., content less than 256 bytes) of the one or more of the memory blocks 104, the identifiers 108 being assigned to the one or more of the memory blocks 104 with the content 106 simplifies the access to one read request.

As illustrated in FIG. 5, at step 508, the controller 102 can output the identifiers 108. For example, the controller 102 can output the identifiers 108 for the set of one or more of the memory blocks 104 of virtual memory. To retrieve the content 106, the controller 102 can pass and/or provide the identifiers 108 to the read arbitrator 140 to retrieving the memory blocks 104 holding the content 106.

FIG. 6 is a flow diagram of an example computer-implemented method 600 for memory management. The computer-implemented method 600 includes techniques for tracking access to memory, efficiently handling simultaneous requests for access to the memory to stream the content (e.g., packets or messages), and managing the memory. The steps shown in FIG. 6 can be performed by any suitable computer-readable code and/or circuit arranged to perform the computer-implemented method 500, including system 100 in FIG. 1, system 200 in FIG. 2, system 300 in FIG. 3, system 400 in FIG. 4, and/or variations or combinations of one or more of the same. In one example, each of the steps shown in FIG. 6 can represent an algorithm whose structure includes and/or is represented by multiple sub-steps, examples of which will be provided in greater detail below.

As illustrated in FIG. 6, at step 602, the controller 102 can track access to the memory 120 to retrieve the memory blocks 104. The controller 102 can monitor access to the memory 120 to identify the memory banks 122 that are available by tracking which memory banks 122 are being utilized to read or write the memory blocks 104 based on the identifiers 108 to read or write the content 106. For example, collisions can occur when multiple RAM requests point to the same memory bank. The controller 102 can buffer such requests into independent and asynchronous RAM access channels.

In some implementations, the controller 102 can assign a tag to each memory access for each of the identifiers 108 representing sets of the memory blocks 104 of in the memory banks 122. The controller 102 can assign tags to memory access requests (e.g., read or write) to identify when all the requests pointing to the memory bank have accessed the memory bank. In some implementations, the controller 102 can store the one or more tags in a tag queue. These tags can be queued in a queue per channel basis, and the identifiers 108 for sets of the memory blocks 104 whose first and last blocks (e.g., head and tail) can be edited by the controller 102 to avoid having to store the tags during the memory access buffering.

Based on the tags, the controller 102 identify when the memory banks can be freed for subsequent access requests to avoid access request collisions. For example, the controller 102 can determine when each request pointing to the memory bank that has been split and buffered in multiple asynchronous channels has come out entirely from the buffering. The controller 102 can set and modify a counter based on the number of tags pushed to the tag queue and the number of tags buffered and popped from the queue. In some implementations, the controller 102 can utilize bit-mask accounting for all channels so that when a channel completes its part of a given memory access request, the controller 102 can modify the corresponding bit in the counter. When all channels have the corresponding bit unset, the controller 102 can identify that the memory access request is complete. In some implementations, the controller 102 can remove a respective tag from the memory queue after outputting an identifier associated with the respective tag. For example, after outputting the identifiers 108, the tag can be removed because the access request to the memory bank has been fulfilled.

As illustrated in FIG. 6, at step 604, the controller 102 can coordinate efficient memory access. For example, in step 604, the controller 102 can select which of the identifiers 108 to access to retrieve the memory blocks 104, which can in some cases be done in a manner to increase efficiency of memory access across multiple requests. The controller 102 can maintain an array that stores the identifiers 108 of the memory blocks 104 stored in memory 120, but only a subset of the identifiers 108 can be accessed per clock cycle. The number of the identifiers 108 accessed per clock cycle can be the number of read/write channels. For example, the array can include X number of the identifiers 108 but only Y number of the identifiers 108 can be accessed per clock cycle. To output sets of the identifiers 108 that can be read in parallel (e.g., during one clock cycle), the controller 102 can apply a multiplexed operation to the array. For example, the operation can be: (4*((X/Y):1))+(4*((Y*Y):1)).

To handle multiple access requests (e.g., read and/or writes) in parallel, the controller 102 can apply a first stage of the multiplexed operation. For example, the operation can be (4*((X/Y):1)). The controller 102 can segment or group the array based on how many of the identifiers 108 can be accessed per clock cycle. The controller 102 can apply a bitmask to the array. For example, the bitmask can be X bits to correspond to X number of identifiers. After applying the bitmask (e.g., OR operation) to the array, the bitmask can indicate the group of the identifiers 108 that can be output in the current clock cycle. For example, the bits of the bitmask that are set high can indicate the group of the identifiers 108 that can be output in the current clock cycle.

The controller 102 can apply a first stage of the multiplexed operation. For example, the operation can be (4*((Y*Y):1)). The controller 102 can identify groups of identifiers (e.g., number of identifiers) be based on the number of identifiers can be accessed per clock cycle. For example, the controller 102 can identify Y groups if Y number of identifiers can be accessed per clock cycle. The groups of the identifiers 108 can be stored, such as in Y groups of Y registers to hold Y*Y entries of identifiers 108. The controller 102 can apply a bitmask to each of the groups of registers to identify a group of the identifiers 108 identified that can be accessed during a particular clock cycle. For example, the controller 102 can apply an OR operation to the groups of registers. The respective groups of bits from both stages of the multiplexed operation can be combined to identify the identifiers 108 that can be accessed during a particular clock cycle.

As illustrated in FIG. 6, at step 606, the controller 102 can utilize an adapter 302 to facilitate communications with the memory 120. For example, if the write controllers 130 and the read controllers 142 work in a 4-way segmented basis and thus have 4 origin channels connected to 4 memory channels of the memory 120, the read and write requests may collide, which can cause them to be delayed or corrupted. The adapter 302 can include one or more additional adapter channels across which to distribute the requests to mitigate the effects of such collisions.

As illustrated in FIG. 3, the controller 102 can be connected to the memory 120 for storing and accessing the memory blocks 104 stored therein by the write controllers 130 and the read controllers 142. The adapter 302 can include one or more adapter channels to provide additional bandwidth relative to the bandwidth of the write controllers 130 and the read controllers 142. The adapter channels can be connected to the memory 120 for storing and accessing the memory blocks 104 stored therein. The adapter channels increase bandwidth between the write controllers 130 and the read controllers 142 and the memory 120 by distributing the requests between the write controllers 130 and the read controllers 142 across the additional adapter channels within the adapter 302.

In some implementations, the controller 102 can identify, via one or more controller communication channels between the write controllers 130 and the memory 120, requests to store content 106 in the memory blocks 104 in the memory banks 122 of the memory 120. The controller 102 can access the adapter 302 to identify, for each access request to the memory 120 from the write controllers 130, the controller communications channels on which the request was transmitted and the order of requests via that controller communication channel. In some implementations, the controller 102 can identify, via one or more controller communication channels between the read controllers 142 and the memory 120, requests to access the content 106 based on with identifiers 108 of the memory blocks 104 stored in the memory banks 122 of the memory 120. The controller 102 can access the adapter 302 to identify, for each access request to the memory 120 from the read controllers 142, the controller communications channels on which the request was transmitted and the order of requests via that controller communication channel.

In some implementations, the controller 102 can utilize the adapter 302 to generate and/or store, for each request, a respective channel identifier of each of the one or more controller channels associated with the respective request. For example, the controller 102 can store that a respective request from the write controllers 130 was transmitted on a respective channel identifier indicating channel 1. In some implementations, the controller 102 can utilize the adapter 302 to generate and/or store, for each request, a respective order identifier indicative of the order in which the request was identified relative to other requests.

The controller 102 can cause the adapter 302 to distribute the requests from one number of origin channels (e.g., 4) to a subset of the greater number of adapter channels (e.g., 5). For example, the controller 102 can use the adapter 302 to distribute requests transmitted from 4 controller channels to 4 of the 5 adapter channels. Since not all the channels of the adapter 302 need to be utilized by a single set of distributed requests, there is a lower probability of collisions with other sets of distributed requests, and any collision across any of the adapter channels would be less problematic. In some implementations, the controller 102 can cause the adapter 302 to transmit the requests from a set of controller communication channels (e.g., from the write controllers 130 or the read controllers 142) to a set of adapter communication channels that interface with the memory 120. The number of controller communication channels can be less than the number of the adapter communication channels. For example, the adapter 302 can allow the requests received from the controllers via four controller communication channels to access the memory 120 via the five adapter communication channels of the adapter 302.

After a read request the memory 120 is transmitted via the adapter 302, the controller 102 can retrieve the memory blocks 104 from the memory 120. The controller 102 can cause the memory blocks 104 to be transmitted via the adapter channels of the adapter 302. The processor can use the respective channel identifier and the order identifier of the read request to distribute the memory blocks 104 from the adapter channels to the controller communication channels. For example, the controller 102 can cause the adapter 302 to redistribute the memory blocks 104 retrieved responsive to the read request from the adapter channels in the adapter 302 to controller communication channels connected to the read controllers 142. Based on the order identifier and the respective channel identifier, the controller 102 can cause the adapter 302 to transmit the memory blocks 104 to the read controllers 142 in a way that is compatible with the segmented data path of the read controllers 142 while maintaining the correct data ordering of the memory blocks 104 and the read requests.

As illustrated in FIG. 6, at step 608, the controller 102 can erase memory blocks 104 stored in memory banks 122 of the memory 120. As illustrated in FIG. 3, the controller 102 can use the reset controller 202 to erase memory blocks 104 in memory banks 122 that are not in use (e.g., not being accessed by the write controllers 130 or read controllers 142). The reset controller 202 can identify the memory banks 122 that will need to be accessed to erase the memory blocks 104. In some implementations, the controller 102 can cause the reset controller 202 to identify a subset of the memory banks 122 that store the set of the memory blocks 104 of virtual memory that are to be reset. In some implementations, the controller 102 can cause the reset controller 202 to identify a set of the memory blocks 104 of virtual memory that are not associated with the identifiers 108. For example, the controller 102 can cause the reset controller 202 to erase the memory blocks 104 after the content 106 that they store has been marked for deletion. In some implementations, the controller 102 can determine to erase memory blocks 104 after the expiration of a timer. For example, the controller 102 can cause the reset controller 202 to erase the memory blocks 104 after monitoring the write controllers 130 and the read controllers 142 to determine that the memory blocks 104 have not been accessed for a preset time. In another example, partially written memory blocks of the memory blocks 104 can be overwritten with zeroes to avoid leaking data between uses of memory blocks 104 for different data streams.

To avoid collisions while erasing the memory blocks 104 the memory banks 122, the controller 102 can cause the reset controller 202 to identify the availability of the memory banks 122 by monitoring the write controllers 130 for writes to those memory banks 122 and monitor the read controllers 142 to detect reads of those memory banks 122. If the reset controller 202 detects that those memory banks 122 are not in use (e.g., not being written or read), the reset controller 202 can transmit the reset signal 204 to erase the memory blocks 104 in those memory banks 122. In some implementations, the controller 102 can cause the reset controller 202 to apply the reset signal 204 to the memory blocks 104 of the memory banks 122.

To erase the memory blocks 104, the controller 102 can cause the reset controller 202 to apply a reset signal 204 to the write arbitrators 132 to cause the memory blocks 104 in the memory banks 122 to be erased. The controller 102 can cause the reset controller 202 to issue zero writes to scrub memory blocks 104 in the memory banks 122 in the memory 120 whenever they are not in use by data pathways so that the memory blocks 104 are freed for storage of the content 106. For example, the controller 102 can cause the reset controller 202 to utilize unused bandwidth to zero out or erase memory blocks 104 while avoiding performance effects on other operations in the memory banks 122. After applying the reset signal 204 to the memory blocks 104, the controller 102 can assign the memory blocks 104 to the listing of available memory blocks of the memory blocks 104 since the memory blocks 104 are available to store the content 106. In some implementations, the controller 102 first assigns the memory blocks 104 to the listing of available memory blocks of the memory blocks 104 and then causes the reset controller 202 to apply the reset signal 204.

As explained above in connection with FIGS. 1-6, the systems described herein can store content in a linked list of memory blocks that can be distributed across physical memory banks. The blocks can assign identifiers to memory access requests (e.g., read or write) to identify when all the requests pointing to a unique block have accessed the unique block, after which the unique memory block can be freed. Access to the blocks can be tracked to identify available memory blocks by tracking which memory blocks are being utilized to read or write the content. To quickly access the blocks stored in memory, the adapter with additional channels can be placed between the controller and the physical memory to increase bandwidth. The memory itself with the blocks can reserve primary memory and common memory to conditionally request additional memory blocks from the common pool if the common pool has the memory blocks available. To free up memory for the content, the reset controller can clean up the memory by issuing zero writes to scrub memory blocks in the physical memory whenever they are not in use by the data pathways so that the memory blocks are freed for use.

By efficiently storing the data in the memory banks, the systems described herein can buffer the data for storing arriving content and then efficiently handle simultaneous requests for access to the memory to stream the content (e.g., packets or messages). The configuration reduces the probability of access collisions when accessing the blocks to retrieve the content, and the blocks are freed when they are not in use. Moreover, the management of the primary and common pools of memory banks memory to be accessible as content arrives in the system and is stored.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of the system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of the system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of the system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of the system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example computer-implemented methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the computer-readable media used to perform the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various implementations of the examples disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method for memory management, the computer-implemented method being performed by a computing device comprising at least one circuit, the computer-implemented method comprising:
storing a content in a physical memory, the storing comprising:
storing the content in a set of one or more memory blocks of virtual memory, wherein the set of one or more memory blocks of virtual memory is allocated for storing the content into one or more of a plurality of memory banks that subdivide the physical memory;
assigning an identifier to the set of one or more memory blocks of the virtual memory that store the content; and
outputting the identifier for the set of one or more memory blocks of the virtual memory; and
during the storing of the content in the physical memory, clearing previously-stored content from the physical memory, the clearing comprising:
applying, via each memory bank of a subset of the plurality of memory banks, a reset signal to at least one block of a second set of one or more memory blocks of the virtual memory, wherein the subset of the plurality of memory banks does not store a block of the set of one or more memory blocks of the virtual memory and will not be in use during the storing of the content in the set.

2.-3. (canceled)

4. The computer-implemented method of claim 1, wherein assigning the identifier comprises:
storing the identifier in an array comprising one or more identifiers for one or more sets of one or more memory blocks of the virtual memory;
applying, responsive to receiving one or more requests for the one or more identifiers, a bitmask to the array based on one or more communication channels associated with the plurality of memory banks; and
outputting a subset of the one or more identifiers based on the array after application of the bitmask.

5. The computer-implemented method of claim 1, further comprising:
assigning a respective identifier to each of one or more sets of one or more memory blocks of the virtual memory that store the content.

6. The computer-implemented method of claim 5, wherein assigning the identifier comprises:
generating a linked list of the set of one or more memory blocks of the virtual memory that stores the content; and
assigning the identifier to a first block of the linked list.

7. The computer-implemented method of claim 5, further comprising:
assigning each block of the one or more sets of one or more memory blocks to a respective memory bank of the plurality of memory banks;
receiving one or more requests for one or more identifiers of the one or more sets of one or more memory blocks of the virtual memory; and
outputting, responsive to receiving the one or more requests, the one or more identifiers in an order based on a number of identifiers associated with each of the plurality of memory banks.

8. The computer-implemented method of claim 5, further comprising:
assigning, based on a size of each memory bank of the plurality of memory banks, the respective identifier to each block of the set of one or more memory blocks of the virtual memory; and
assigning, based on the respective identifier, each of the set of one or more memory blocks of the virtual memory to a respective memory bank of the plurality of memory banks.

9. The computer-implemented method of claim 1, further comprising:
assigning one or more tags to each of one or more requests for one or more identifiers of one or more sets of one or more memory blocks of the virtual memory;
storing the one or more tags in a queue; and
removing a respective tag of the one or more tags from the queue responsive to outputting a respective identifier of the one or more identifiers associated with the respective tag.

10. The computer-implemented method of claim 1, further comprising:
receiving, via one or more communication channels, one or more requests for one or more identifiers of one or more sets of one or more memory blocks of the virtual memory;
storing, for a respective request of the one or more requests, a respective channel identifier of each of the one or more communication channels associated with the respective request; and
transmitting the one or more requests via a plurality of second communication channels, wherein a first number of the one or more communication channels is less than a second number of the plurality of second communication channels.

11. The computer-implemented method of claim 1, wherein:
blocks of the set of one or more memory blocks of the virtual memory, which are subdivided into the plurality of memory banks, are of equal size; and
storing the content in the set of one or more memory blocks of the virtual memory comprises:
storing, responsive to a number of available memory blocks in the physical memory being at least a number of memory blocks in the set of one or more memory blocks of the virtual memory, the content in the set of one or more memory blocks of the virtual memory.

12. The computer-implemented method of claim 11, further comprising:
comparing a number of available memory blocks in a reserved logical partition of the physical memory to the number of memory blocks in the set of one or more memory blocks of the virtual memory; and
selecting at least one of the available memory blocks in the physical memory as a storage location for the content, wherein the identifier identifies the storage location for the content.

13. A system for memory management, the system comprising:
at least one circuit arranged to perform a method comprising:
storing a content in a physical memory, the storing comprising:
storing the content in a set of one or more memory blocks of virtual memory, wherein the set of one or more memory blocks of the virtual memory is allocated for storing the content into one or more of a plurality of memory banks that subdivide the physical memory;
assigning an identifier to the set of one or more memory blocks of the virtual memory that store the content; and
outputting the identifier for the set of one or more memory blocks of the virtual memory; and
during the storing of the content in the physical memory, clearing previously-stored content from the physical memory, the clearing comprising:
applying, via each memory bank of a subset of the plurality of memory banks, a reset signal to at least one block of a second set of one or more memory blocks of the virtual memory, wherein the subset of the plurality of memory banks does not store a block of the set of one or more memory blocks of the virtual memory and will not be in use during the storing of the content in the set.

14. (canceled)

15. The system of claim 13, wherein assigning the identifier comprises:
storing the identifier in an array comprising one or more identifiers for one or more sets of one or more memory blocks of the virtual memory;
applying, responsive to receiving one or more requests for the one or more identifiers, a bitmask to the array based on one or more communication channels associated with the plurality of memory banks; and
outputting a subset of the one or more identifiers based on the array after application of the bitmask.

16. The system of claim 13, wherein the method further comprises:
assigning a respective identifier to each of the set of one or more memory blocks of the virtual memory that store the content.

17. The system of claim 13, wherein the method further comprises:
assigning one or more tags to each of one or more requests for one or more identifiers of one or more sets of one or more memory blocks of the virtual memory;
storing the one or more tags in a queue; and
removing a respective tag of the one or more tags from the queue responsive to outputting a respective identifier of the one or more identifiers associated with the respective tag.

18. The system of claim 13, wherein the method further comprises:
receiving, via one or more communication channels, one or more requests for one or more identifiers of one or more sets of one or more memory blocks of the virtual memory;
storing, for a respective request of the one or more requests, a respective channel identifier of each of the one or more communication channels associated with the respective request; and
transmitting the one or more requests via a plurality of second communication channels, wherein a first number of the one or more communication channels is less than a second number of the plurality of second communication channels.

19. The system of claim 13, wherein:
blocks of the set of one or more memory blocks of the virtual memory, which are subdivided into the plurality of memory banks, are of equal size; and
storing the content in the set of one or more memory blocks of the virtual memory comprises:
storing, responsive to a number of available memory blocks in the physical memory being at least a number of memory blocks in the set of one or more memory blocks of the virtual memory, the content in the set of one or more memory blocks of the virtual memory.

20. A non-transitory computer-readable medium comprising one or more computer-readable instructions that, when executed by at least one circuit, cause the at least one circuit to perform a method comprising:
storing a content in a physical memory, the storing comprising:
storing the content in a set of one or more memory blocks of virtual memory, wherein the set of one or more memory blocks of the virtual memory is allocated for storing the content into one or more of a plurality of memory banks that subdivide the physical memory;
assigning an identifier to the set of one or more memory blocks of the virtual memory that store the content; and
outputting the identifier for the set of one or more memory blocks of the virtual memory; and
during the storing of the content in the physical memory, clearing previously-stored content from the physical memory, the clearing comprising:
applying, via each memory bank of a subset of the plurality of memory banks, a reset signal to at least one block of a second set of one or more memory blocks of the virtual memory, wherein the subset of the plurality of memory banks does not store a block of the set of one or more memory blocks of the virtual memory and will not be in use during the storing of the content in the set.
